(19) United States
(12) Patent Application Publication
(10) Pub. No.: US 2005/0283514 A1
(43) Pub. Date: Dec. 22, 2005

(54) Method and apparatus for calculating a modular inverse

(75) Inventors: Ciaran James McIvor, Belfast (GB); John Vincent McCanny, Newtownards (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: The Queen's University of Belfast - Research & Regional Services

(21) Appl. No.: 11/139,957

(22) Filed: May 27, 2005

(30) Foreign Application Priority Data
May 29, 2004 (GB) 0412084.6

(51) Int. Cl. G06F 7/38

(52) U.S. Cl. 708/491

(57) ABSTRACT

Apparatus for calculating a classical modular inverse or a Montgomery modular inverse of an integer a (mod p), where p is a k-bit integer, comprising: a first calculator operable to calculate an “Almost Montgomery Inverse” of a first input variable; a counter z; a second calculator operable to calculate a Montgomery modular product of the output from the first calculator and the second input variable in the event that z=k;
a third calculator operable to calculate a Montgomery modular product of the output of the first calculator and 2^{2*k-z} in the event that z≠k; a fourth calculator operable to calculate a Montgomery modular product of the output from the third calculator and the second input variable in the event that z≠k; and further comprising a selector for selecting a first and second input variable when calculating the classical modular inverse being different from the first and second input variables selected when calculating the Montgomery modular inverse.

This application claims the benefit of Great Britain Patent Application No. 0412084.6, filed on 29 May 2004, which is hereby incorporated by reference.

### FIELD OF THE INVENTION

The present invention relates to a method and apparatus for calculating a modular inverse.

### BACKGROUND OF THE INVENTION

The background of the invention will now be described with reference to the accompanying tables in which:
Table 1 shows the input and output variables employed in the Kaliski method of calculating a classical modular inverse and a Montgomery modular inverse;
Table 2 provides a pseudo-code listing of the steps involved in the implementation of the Kaliski method of calculating a classical modular inverse and a Montgomery modular inverse;
Table 3 shows the input and output variables employed in the Savas and Koç method of calculating a classical modular inverse and a Montgomery modular inverse; and

Table 4 provides a pseudo-code listing of the steps involved in the implementation of the Savas and Koç method of calculating a classical modular inverse and a Montgomery modular inverse.

TABLE 1

| | Kaliski ModInv(a) | Kaliski MonInv(a) |
|---|---|---|
| Input | a, p | a2^{k} (mod p), p, k, 2^{2k} (mod p) |
| Output | a⁻¹ (mod p) | a⁻¹2^{k} (mod p) |

TABLE 2

| | Kaliski ModInv(a) | Kaliski MonInv(a) |
|---|---|---|
| Step 1 | $\begin{matrix}r = Phase1 ( \text{a} ) \\ = {a}^{- 1} {2}^{z} ( mod p )\end{matrix}$ | $\begin{matrix}r = Phase1 ( {a2}^{k} ) \\ = {a}^{- 1} {2}^{- k} {2}^{z} ( mod p ) ;\end{matrix}$ |
| Step 2 | for i = 1 to z | for i = 1 to z − k |
| | if r is even then | if r is even then |
| | r = r/2 | r = r/2 |
| | else r = (r + p)/2 | else r = (r+ p)/2 |
| Step 3 | Return | r = MP(r, 2^{2k}) |
| | r = a⁻¹ (mod p) | Return |
| | | r = a⁻¹2^{k} (mod p); |

TABLE 3

| | Savas/Koç ModInv(a) | Savas/Koç MonInv(a) |
|---|---|---|
| Input: | a, p, m | a2^{m} (mod p), p, m, R² |
| Output: | a⁻¹ (mod p) | a⁻¹2^{m} (mod p) |

TABLE 4

| | Savas/Koç ModInv(a) | Savas/Koç MonInv(a) |
|---|---|---|
| Step 1: | $\begin{matrix}r = Phase1 ( \text{a} ) \\ = {a}^{- 1} {2}^{z} ( mod p )\end{matrix}$ | $\begin{matrix}r = Phase1 ( {a2}^{m} ) \\ = {a}^{- 1} {2}^{- m} {2}^{z} ( mod p ) ;\end{matrix}$ |
| Step 2 | $\begin{matrix}if z > m then \\ \begin{matrix}r = MP ( r , 1 ) \\ = {a}^{- 1} {2}^{z - m} ( mod p ) ;\end{matrix} \\ z = z - m < m ;\end{matrix}$ | $\begin{matrix}if k \leq z \leq m then \\ \begin{matrix}r = MP ( r , {R}^{2} ) \\ = {a}^{- 1} {2}^{z} ( mod p ) ;\end{matrix} \\ z = z + m > m ;\end{matrix}$ |
| Step 3 | $\begin{matrix}r = MP ( r , {2}^{m - z} ) \\ = {a}^{- 1} ( mod p ) ;\end{matrix}$ | $\begin{matrix}r = MP ( r , {R}^{2} ) \\ = {a}^{- 1} {2}^{z} ( mod p ) ;\end{matrix}$ |
| Step 4 | Return r = a⁻¹ (mod p); | $\begin{matrix}r = MP ( r , {2}^{2 m - z} ) \\ = {a}^{- 1} {2}^{m} ( mod p ) ;\end{matrix}$ |
| Step 5 | | Return r = a⁻¹2^{m} (mod p); |

Recent years have seen rapid growth in the area of electronic communications and electronic commerce (e.g. email, online shopping and online banking). With this growth, there has been increased demand for mechanisms of ensuring the security of such communications. Public key encryption systems are useful in this context as they provide the features of confidentiality, authentication, data integrity and non-repudiation.

Accordingly, the problem facing the security industry is that of producing high-speed, low-cost and robust cryptographic products in order to satisfy customer demands for real-time encryption and repel cryptanalytic attacks.

Modular arithmetic is a key ingredient of many public key crypto-systems. It provides finite structures (called “rings”) which have all the usual arithmetic operations of integers and which can be easily implemented with existing computer hardware.

Given an integer a and a k-bit integer p (2^{k-1}≦p<2^{k}), a⁻¹ (mod p) is the modular (multiplicative) inverse of a (mod p) and is classically defined as the integer ModInv(a) such that
a*ModInv(a)=1(mod p) (1)

The above expression only has a unique solution if a and p are relatively prime.

Modular multiplicative inversion has a number of uses in cryptography. In particular, one its main uses is in the generation of private keys from public keys in accordance with the well-known RSA algorithm. These private keys are used to decrypt a message encrypted (by the RSA algorithm) with the public key. Such private keys may also be used as digital signatures to enable the identification of the originator of a digital communication and to guarantee the integrity of the communication.

Modular multiplicative inversion is also used in a wide variety of elliptic curve cryptosystems. For instance, the El Gamal algorithm is based on the multiplication of a secret integer with a point on an elliptic curve to generate a public key. A digital communication is then encrypted by further scalar multiplication with the public key. The above scalar point multiplications can be represented as a number of point addition and doubling operations which are based on the calculation of modular multiplicative inverses.

Modular inverses have been traditionally calculated using the extended Euclidean algorithm. However, this algorithm is iterative in nature and thus, may be slow to calculate the modular inverse of a large number. This feature is becoming increasingly problematic as ever larger keys are used to make it more difficult for unauthorised persons to crack encryption schemes. In view of the problems with the extended Euclidean algorithm and the demand for high-speed or real-time encryption, one of the main objectives of the present invention is to provide a mechanism for rapidly calculating modular inverses for use in RSA key generation and elliptic curve cryptography.

Modular inverses are also used for calculating modular exponents that are used in the RSA algorithm, Diffie Hellman key exchange scheme and El Gamal encryption scheme. One method of performing modular exponentiation is to break it up into a series of modular multiplication operations in an addition-subtraction chaining approach. Using this approach, given integers integer a, c and p where a<p, the modular exponent a^{c} (mod p) can be calculated by multiplying intermediate values starting with a and a⁻¹(mod p).

The Montgomery multiplication algorithm (P. L. Montgomery, Math. Computation (44) 519-521) is a technique that provides an efficient mechanism for implementing modular multiplication. In particular, given an integer a<n, where p is a k-bit integer (2^{k-1}≦p<2^{k}), A is said to be its p-residue with respect to r=2^{k} if,
A=a*r(mod p) (2)

Likewise, given an integer b<p, B is said to be its p-residue with respect to r if,
B=b*r(mod p) (3)

The Montgomery product of the two residues A and B can then be defined as the scaled product,
MP=A*B*2⁻¹(mod p) (4)
where r⁻¹ is the multiplicative inverse of r modulo p (i.e. r*r⁻¹=1 (mod p)).

However, since r=2^{k}, the Montgomery product can also be represented as
MP=A*B*2^{-k}(mod p) (5)

From this expression it can be seen that the Montgomery multiplication algorithm effectively replaces the step of division by p in an ordinary modular multiplication process with a division by a power of two (i.e. a shift operation).

Consequently, the Montgomery multiplication algorithm is particularly suited to the inherently binary nature of general-purpose computers and provides a simpler and faster method of performing modular multiplication than more traditional methods.

The above-described Montgomery multiplication algorithm can also be used to calculate modular exponents in an addition-subtraction chaining approach. Using this approach, the modular exponent a^{c} (mod p) may be calculated from intermediate values starting with a*2^{k}(mod p) and a⁻¹*2^{k} (mod p).

Using the representation scheme employed in the Montgomery multiplication algorithm the Montgomery modular inverse of an integer a (henceforth referred to as MonInv(a)) is defined as
MonInv(a)=a⁻¹*2^{k} (mod p) (6)

At present, there are two methods available for calculating a Montgomery modular inverse, namely the Kaliski method and the Savas and Koç method. Both of these methods will be discussed in more detail below.

(a) Kaliski Method of Calculating a Montgomery Modular Inverse

Kaliski (B. S. Kaliski, IEEE Trans. Computers 44(8), 1064-1065) developed a two stage algorithm for calculating the Montgomery modular inverse. In the first stage an “Almost Montgomery Inverse” is calculated, wherein the “Almost Montgomery Inverse” (Phase1 (a)) is defined as
Phase1(a)=a⁻¹ 2^{z}(mod p) (7)
where z is an integer and k≦z≦2k.

The second stage of Kaliski's algorithm completes the operation by using the “Almost Montgomery Inverse” (Phase1 (a)) and z to calculate MonInv(a).

A variant of the Kaliski algorithm can be used for calculating a classical modular inverse. Accordingly, there are two separate Kaliski algorithms, the first of which (Kaliski ModInv( )) provides a mechanism of calculating a classical modular inverse and the second of which (Kaliski MonInv( )) provides a mechanism of calculating a Montgomery modular inverse of an integer already in the Montgomery domain.

The input and output variables to the two Kaliski algorithms are outlined in Table 1. The steps involved in the implementation of the two Kaliski algorithms are shown in Table 2. Referring to Table 2 it can be seen that both Kaliski algorithms employ recurrence loops to achieve inversion.

b) Savas and Koç Method of Calculating a Montgomery Modular Inverse

Savas and Koç (E. Savas and C. K Koç: IEEE Trans. on Computers, 49(7), 763-766) suggested that Montgomery multiplication could be used to replace the iterative loops in the Kaliski algorithms. In particular, if m is defined to be an integer multiple of the word size (w) of the host computer system and m≧k, the output z from Phase 1 of the Kaliski method is an integer satisfying k≦z≦k+m. The Savas and Koç algorithms further assume that R²=2^{2m}(mod p) and the inputs to the Montgomery product function (MP) are m-bit integers.

In a similar fashion to the Kaliski algorithms, a variant of the Savas and Koç algorithm can be used for calculating a classical modular inverse. Accordingly, there are two separate Savas and Koç algorithms, the first of which (Savas/Koç ModInv( )) provides a mechanism of calculating a classical modular inverse and the second of which (Savas/Koç MonInv( )) provides a mechanism of calculating a Montgomery Modular Inverse.

The input and output variables to the two Savas and Koç algorithms are outlined in Table 3. Table 4 outlines the steps involved in the implementation of the two Savas and Koç algorithms.

Referring to Table 4 it can be seen that the Savas and Koç ModInv( ) algorithm involves one or two Montgomery multiplication operations. Similarly, the Savas and Koç MonInv( ) algorithm involves two or three Montgomery multiplication operations.

Both the Kaliski and Savas and Koç algorithms were originally developed for software implementation. If these algorithms were to be implemented in hardware, then two separate circuit architectures would be required.

### SUMMARY OF THE INVENTION

According to the invention there is provided a method of calculating a classical modular inverse or a Montgomery modular inverse of an integer a (mod p), where p is a k-bit integer, comprising the steps of:
(1) calculating the “Almost Montgomery Inverse” of a first input variable;
(2) maintaining an integer variable z;
(3) calculating the Montgomery modular product of the output from (1) and a second input variable in the event that z=k;
(4) (a) calculating the Montgomery modular product of the output from (1) and 2^{2*k-z}; and
(b) calculating the Montgomery modular product of the output from 4a and the second input variable in the event that z≠k;
and further comprising the step of:
   selecting a first and second input variable when calculating the classical modular inverse being different from the first and second input variables selected when calculating the Montgomery modular inverse.

Preferably, the first input variable is a and the second input variable is one when calculating a classical modular inverse; and the first input variable is a2^{k} mod(p) and the second input variable is R² when calculating the Montgomery modular inverse.

According to a second aspect of the invention there is provided an apparatus for calculating a classical modular inverse or a Montgomery modular inverse of an integer a (mod p), where p is a k-bit integer, comprising:
a first calculating means operable to calculate an “Almost Montgomery Inverse” of a first input variable;
a counting means z;
a second calculating means operable to calculate a Montgomery modular product of the output from the first calculating means and the second input variable in the event that z=k;
a third calculating means operable to calculate a Montgomery modular product of the output of the first calculating means and 2^{2*k-z} in the event that z≠k;
a fourth calculating means operable to calculate a Montgomery modular product of the output from the third calculating means and the second input variable in the event that z≠k;
and further comprising a means of selecting a first and second input variable when calculating the classical modular inverse being different from the first and second input variables selected when calculating the Montgomery modular inverse.

Preferably, the first input variable is a and the second input variable is one when calculating a classical modular inverse and the first input variable is a2^{k} (mod p) and the second input variable is R² when calculating a Montgomery modular inverse.

Preferably, the apparatus further comprises a means of transmitting the output of the fourth calculating means.

Preferably, the second calculating means is implemented in a control unit that further comprises a logic unit which compares z and k.

Desirably, the second, third and fourth calculating means comprise a multiplier unit, an addition unit and a subtraction unit.

Desirably, the addition unit and the subtraction unit employ fast carry chains and two's complement addition.

Desirably, the multiplier unit comprises a plurality of cascaded unsigned multiplier units.

Preferably, the multiplier unit comprises a means of adding the outputs from the unsigned multiplier units employing look-ahead carry chains.

Preferably, the apparatus is a field programmable gate array.

Optionally, the apparatus is an application specific integrated circuit.

Preferably, the apparatus operates on 256 bit data.

According to a third aspect of the invention there is provided a method of generating a private encryption key from a public encryption key by calculating the modular inverse of the public encryption key with the method of the first aspect.

Preferably, the private encryption key is employed in an RSA algorithm.

According to a fourth aspect of the invention there is provided an apparatus for generating a private encryption key from a public encryption key comprising a means for performing the method of the third aspect.

According to a fifth aspect of the invention there is provided a digital signature generated from the private key produced by the method of the third aspect.

According to a sixth aspect of the invention there is provided a method of encrypting data comprising the steps of:
selecting a point on an elliptical curve;
determining a public key from the point on the elliptical curve and a pre-selected number; and
encrypting the data with the public key
wherein the steps of determining the public key and encrypting the data with the public key employ the method of the first aspect.

According to a seventh aspect of the invention there is provided an apparatus for encrypting data comprising:
a means of selecting a point on an elliptical curve;
a means of determining a public key from the point on the elliptical curve and a pre-selected number; and
a means of encrypting the data with the public key
wherein the means of determining the public key and the means of encrypting the data with the public key employ the apparatus of the second aspect.

### ADVANTAGES OF THE INVENTION

The present invention improves on the algorithms developed by Kaliski and Savas and Koç by providing a single unified algorithm that can compute both the classical modular inverse and the Montgomery modular inverse of an integer. Accordingly, the present invention provides a mechanism for substantially reducing the silicon usage of hardware implementations of traditional modular inversion algorithms.

Whilst the present invention, in common with the Kaliski and Savas and Koç algorithms, performs Montgomery modular multiplication, it achieves a 33% reduction in the number of such multiplication operations compared with the prior art algorithms.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram of a 256-bit circuit architecture according to the second aspect employed to calculate a classical modular inverse;

FIG. 2 is a block diagram of a 256-bit Montgomery multiplication module employed in the circuit architecture shown in FIG. 1;

FIG. 3 is a block diagram of a cascaded multiplier used in a multiplier unit in the Montgomery multiplication module shown in FIG. 2;

### DETAILED DESCRIPTION OF THE PREFERRED EMBODIMENTS

Reference will now be made in detail to the preferred embodiment of the present invention, example of which is illustrated in the accompanying drawings and the following tables:
Table 5 lists input and output variables employed in the method according to the first aspect;
Table 6 comprises pseudo-code that outlines the steps involved in implementing the method according to the first aspect;
Table 7 comprises pseudo-code that outlines the steps involved in performing a Phase1 calculation in the implementation shown in Table 6;
Table 8 comprises pseudo-code that outlines the steps involved in performing a Montgomery multiplication operation in the implementation shown in Table 6; and

Table 9 lists the results of the comparative analysis of the performance of the hardware implementations of the method according to the first aspect and the conventional Kaliski and Savas and Koç algorithms.

TABLE 5

| | Classical Modular | Montgomery Modular |
|---|---|---|
| | Inverse Calculations | Inverse Calculations |
| Input | a, p, k, 1 | a2^{k} (mod p), p, k, R² |
| Output | a⁻¹ (mod p) | a⁻¹2^{k} (mod p) |

TABLE 6

| | Classical Modular | Montgomery Modular |
|---|---|---|
| | Inverse Calculations | Inverse Calculations |
| Step 1 | $\begin{matrix}r = Phase1 ( \text{a} ) \\ = {a}^{- 1} {2}^{z} ( mod p )\end{matrix}$ | $\begin{matrix}r = Phase1 ( {a2}^{k} ) \\ = {a}^{- 1} {2}^{- k} {2}^{z} ( mod p ) ;\end{matrix}$ |
| Step 2 | $\begin{matrix}if z = k then \\ \begin{matrix}r = MP ( r , 1 ) \\ = {a}^{- 1} ( mod p ) ;\end{matrix} \\ else \\ \begin{matrix}r = MP ( r , {2}^{k - z} ) \\ = {a}^{- 1} {2}^{k} ( mod p ) ; \\ r = MP ( r , 1 ) \\ = {a}^{- 1} ( mod p ) ;\end{matrix}\end{matrix}$ | $\begin{matrix}if z = k then \\ \begin{matrix}r = MP ( r , {R}^{2} ) \\ = {a}^{- 1} {2}^{k } ( mod p ) ;\end{matrix} \\ else \\ \begin{matrix}r = MP ( r , {2}^{k - z} ) \\ = {a}^{- 1} ( mod p ) ; \\ r = MP ( r , {R}^{2} ) \\ = {a}^{- 1} {2}^{k} ( mod p ) ;\end{matrix}\end{matrix}$ |
| Step 3 | Return | Return |
| | r = a⁻¹ (mod p); | r = a⁻¹2^{k} (mod p); |

TABLE 7

Input: a, p where a < p;
Output: Phase1 (a) = a⁻¹ 2^{z} (mod p), z where k ≦ z ≦
2k;
1. u = p; v = a; s₁ = 0; s₂ = 1; z = 0;
2. while v > 0 loop

if u is even then

u = u/2; s₂ = 2s₂;

elsif v is even then

v = v/2; s₁ = 2s₁;

elsif u > v then

u = (u − v)/2; s₁ = s₁ + s₂; s₂ = 2s₂;

elsif v ≧ u then

v = (v − u)/2; s₂ = s₂ + s₁; s₁ = 2s₁;

end if;
z = z + 1;

end loop;

3. if s₁ ≧ p then s₁ = s₁ − p;
4. return Phase1 (a) = p − s₁;

return z;

TABLE 8
$\begin{matrix}Step 1 \text{:} = A * B ; \\ Step 2 \text{:} u = \frac{( t + [ t * {n}^{′} ( modr ) ] * n )}{r} ; \\ \begin{matrix}Step 3 \text{:} if u \geq n then return u - n \\ else return u ;\end{matrix}\end{matrix}$

TABLE 9

| | Clock | | | | Function | % Speed-up with | % Area Saved with |
|---|---|---|---|---|---|---|---|
| | Speed | Clock | Inversion | Area | Inverse | Unified Inversion | Unified Inversion |
| Algorithm | (MHz) | Cycles | Time (μs) | Slices | Type | Algorithm | Algorithm |
| Kaliski | 57.75 | 1029 | 17.82 | 3,193 | Classical | 17.8% | 18.8% |
| ModInv( ) | | | | | | | |
| Kaliski | 40.18 | 807 | 20.08 | 15,029 | Montgomery | 27.1% | |
| MonInv( ) | | | | | | | |
| Savas/Koç | 40.46 | 585 | 14.46 | 14,723 | Classical | −1.2% | 49.9% |
| ModInv( ) | | | | | | | |
| Savas/Koç | 40.68 | 619 | 15.22 | 14,844 | Montgomery | 3.8% | |
| MonInv( ) | | | | | | | |
| Unified | 40.04 | 586 | 14.64 | 14,800 | Classical & | N/A | N/A |
| Inversion | | | | | Montgomery | | |

For the sake of brevity, the method of calculating a classical modular inverse and a Montgomery modular inverse of an integer in accordance with the invention will be known henceforth as the unified inversion algorithm. Accordingly, the following description will first describe the unified inversion algorithm and will provide evidence of its advantages by way of a hardware implementation.

A. Unified Inversion Algorithm

As previously mentioned, the unified inversion algorithm provides a single, efficient algorithm for computing both the classical modular inverse and the Montgomery modular inverse of an integer already in the Montgomery domain. The algorithm is a two-stage process in which the output from the first stage (in common with the output from the first stage of the Kaliski algorithms) is the integer satisfying k≦z≦2k. The unified inversion algorithm further assumes that R²=2^{2k}(mod p) and the inputs to the Montgomery modular multiplication function (MP( )) are k-bit integers.

For the sake of clarity, the following discussion will separately discuss the classical modular inverse calculation steps from those of the Montgomery modular inverse calculations. However, it will be realised that in actuality, these calculations are embraced within the same single algorithm and that the separation of these calculations in the following discussion is solely for the purpose of clarifying the description. Consequently, the following description should be in no way construed as meaning that there are two separate algorithms for calculating the modular inverses.

Referring to Table 5, it will be noted that in order to calculate the classical modular inverse (ModInv(a)) the pair of variables (a, 1) is input to the unified inversion algorithm. Similarly, in order to calculate the Montgomery modular inverse (MonInv(a)) of an integer already in the Montgomery domain, the pair (a2^{k} (mod p), R²) are input to the unified inversion algorithm.

It will be recalled the Savas and Koç algorithm for calculating a Montgomery modular inverse required a maximum of three Montgomery multiplication operations. Referring to Table 6 it will be noted that the unified inversion algorithm is more efficient than the Savas and Koç algorithm for computing a Montgomery modular inverse, since the unified inversion algorithm requires at most only two Montgomery multiplication operations. Consequently, the unified inversion algorithm provides at least a 33% saving in the required number of Montgomery multiplication operations.

Furthermore, the unified inversion algorithm is particularly suited for hardware (and indeed software) implementations, since a single circuit architecture can be used to compute both types of modular inverse.

B. Field Programmable Gate Array (FPGA) Hardware Implementation of the Unified Inversion Algorithm

The following discussion will provide a broad overview of an example of a hardware implementation of the unified inversion algorithm. This will be followed with a more detailed description of a hardware implementation of a Montgomery multiplication component of the unified inversion algorithm. The description will finish with experimental results providing a comparative analysis of the performance of the hardware implementation of the unified inversion algorithm, with hardware implementations of the conventional Kaliski and Savas and Koç algorithms. For the sake of brevity, the hardware implementation of the unified inversion algorithm will be known henceforth as the unified inversion circuit.

The following discussion describes an example of a 256-bit hardware implementation of the unified inversion algorithm. It will be appreciated that the unified inversion algorithm is not limited to the specific details of the hardware implementation described below and that other hardware implementations of the algorithm are possible.

1. Overview

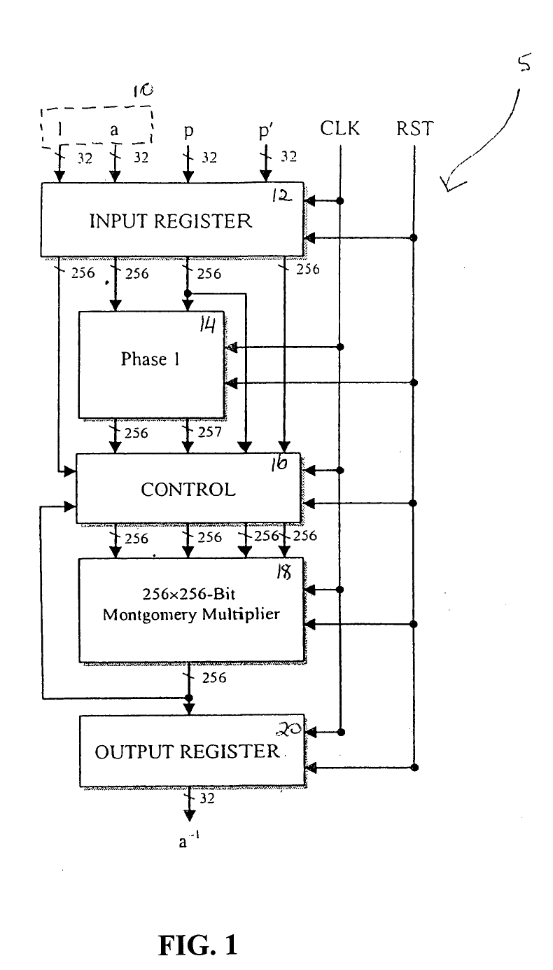

Referring to FIG. 1, when computing a classical modular inverse, the unified inversion circuit 5 employs input values 10 of a and l. However, when calculating the Montgomery modular inverse of an integer already in the Montgomery domain, input values 10 of a^{2k} (mod p) and R² are employed.

Returning to the example depicted in FIG. 1, the input values 10 are registered 12 into the unified inversion circuit 5 at 32-bits per clock cycle over 8 cycles. The values a and p are then fed into a Phase1 component 14, which comprises a 256-bit adder and subtractor (not shown), implemented using fast carry chains located on, for example, a Virtex2 Pro device. The addition and subtraction operations are performed sequentially in accordance with the pseudo-code shown in Table 7, using a state machine approach.

The resulting values Phase1(a) and z are then stored in a control unit 16. The value 2^{2k-z} is also calculated in the control unit 16. A comparison between z and k is also performed in the control unit 16 to determine the inputs to a 256-bit Montgomery multiplier 18. In particular, if z=k then only one modular multiplication is required. However, if z≠k two multiplication operations are required and the output variable r₁ from the Montgomery multiplier 18 is fed back into the control unit 16 to be reused as an input to the Montgomery multiplier 18. Once the necessary modular multiplications have been completed, the variable a⁻¹ is output 20 from the unified inversion circuit 5 at 32-bits per clock cycle over 8 cycles.

2. Montgomery Multiplier (18)

2(a) Overview

The steps performed in the Montgomery multiplier 18 are shown in Table 8. It will be noted that the Montgomery multiplication algorithm assumes that n is the k-bit modulus of integers A and B, r=2^{k}, rr⁻¹−nn′=1 and r⁻¹r=1 (mod n). The main calculations performed in the Montgomery multiplication algorithm include three full-word multiplications, one full-word addition, and a conditional full-word subtraction. In practice, the full-word addition and subtraction operations are performed using fast carry chains and two's-complement addition.

2(b) Hardware Implementation

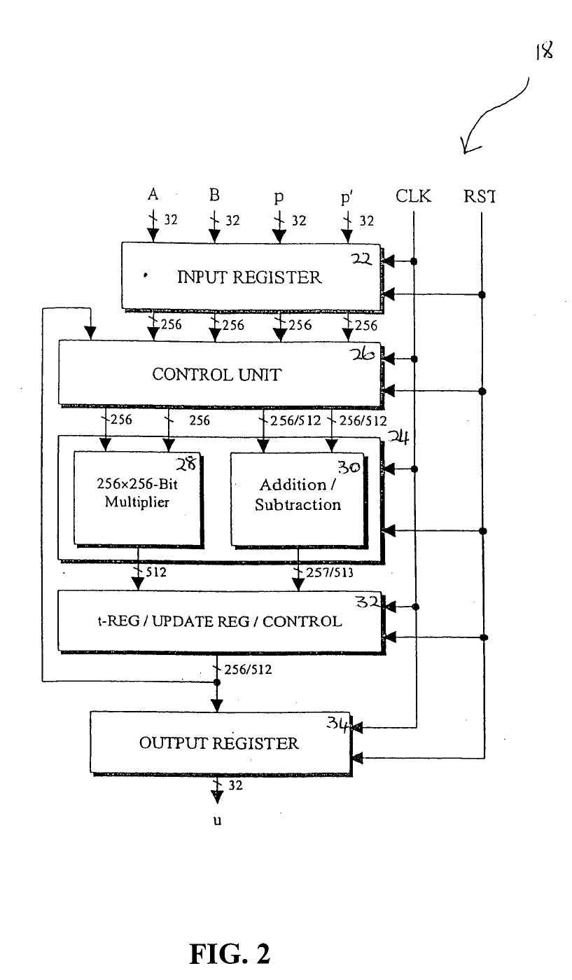

Referring to FIG. 2, the inputs to the 256-bit Montgomery multiplier architecture 18 are registered 22 into the Montgomery multiplier 18 at a rate of 32-bits per clock cycle over a period of 8 cycles. The main calculation operations of the Montgomery multiplication algorithm are performed in a calculation unit 24 that operates under the control of a control unit 26. The calculation unit 24 comprises a 256×256 bit multiplier unit 28 and an addition/subtraction unit 30.

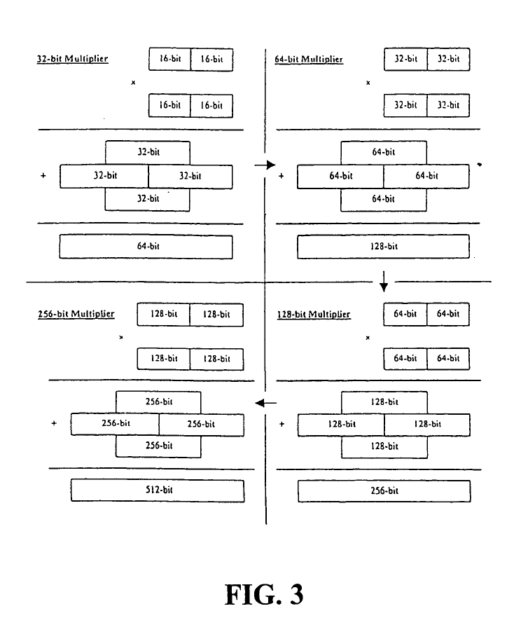

Referring to FIG. 3, the 256×256-bit multiplier unit 28 is developed by cascading numerous 16×16-bit unsigned multipliers. The partial products from the cascaded 16×16-bit unsigned multipliers are added together using fast look-ahead carry chains until the desired multiplier size is attained. The calculation and addition of the partial products from the cascaded 16×16-bit unsigned multipliers is a fully pipelined process, designed to take full advantage of the small critical path delay of the 16×16-bit multiplier blocks and the fast carry chains. Therefore it takes 3, 5, 7, and 9 clock cycles to respectively complete 32, 64, 128, and 256 bit multiplication operations.

Returning to FIG. 2, the control unit 26 determines the order in which the multiplications, addition and conditional subtraction operations of the calculation unit 26 are performed.

The t-REG/UPDA TE REG/CONTROL component 32 stores the product t=A*B and the results of the other multiplication and addition operations, which are then fed back into the control unit 26 to be re-used as inputs to the 256×256-bit multiplier unit 28 or Addition/Subtraction component 30. The t-REG/UPDATE REG/CONTROL component 32 also performs the trivial mod and div operations. Once the conditional subtraction has been performed, the variable u is output from the output register 34 at a rate of 32-bits per cycle over a period of 8 clock cycles.

3. Comparative Performance Analysis

The performance of the unified inversion algorithm compared with the Kaliski and Savas and Koç algorithms was investigated by capturing the algorithms in VHDL and implementing the algorithms on a Xilinx Virtex2 Pro XC2VP125 FPGA (using a 256-bit operand length). The Montgomery multiplication calculations were performed using the algorithm described by Koç et al. (C. K. Koç, T. Acar and B. S. Kaliski, IEEE Micro, 16(3), 26-33).

Table 7 shows the results of experiments (obtained using Xilinx Foundation software v6.1.03i) comparing the performance of the above algorithms. Referring to Table 7, it can be seen that using the unified inversion algorithm instead of Kaliski's algorithms to calculate the classical inverse and the Montgomery modular inverse of an integer already in the Montgomery domain, results in a speed up of 17.8% and 27.1% respectively.

Furthermore, because a modular inverter circuit can be implemented using a single unified inversion circuit in place of the two separate circuits required to implement both of Kaliski's algorithms, an overall reduction of 18.8% in the number of slices used is achievable. This percentage is a relative measure calculated by computing the difference between the number of slices required to implement Kaliski's algorithms and the number of slices required by the unified inversion circuit; and then dividing the difference by the number of slices required to implement Kaliski's algorithms.

Whilst the unified inversion algorithm does not provide a significant speed-up if used instead of the Savas/Koc algorithms, nonetheless, the unified inversion circuit provides a 49.9% reduction in the silicon area usage compared with the Savas and Koç algorithms (using the same relative measurement as used when comparing against the Kaliski algorithms).

Similar speed-ups and savings in source code/silicon area are attainable if the unified inversion, Kaliski and Savas and Koç algorithms are implemented in-software or alternative hardware media, e.g. modern application specific integrated circuit (ASIC) devices, since the unified inversion algorithm has an inherently less complicated structure than the other algorithms.

Modifications and alterations may be made to the above without departing from the scope of the invention.

1. Method of calculating a classical modular inverse or a Montgomery modular inverse of an integer a (mod p), where p is a k-bit integer, comprising the steps of:
(1) calculating the “Almost Montgomery Inverse” of a first input variable;
(2) maintaining an integer variable z;
(3) calculating the Montgomery modular product of the output from step (1) and a second input variable in the event that z=k;
(4) (a) calculating the Montgomery modular product of the output from step (1) and 2^{2*k-z}; and
(b) calculating the Montgomery modular product of the output from 4a and the second input variable in the event that z≠k;
and further comprising the step of:
selecting a first and second input variable when calculating the classical modular inverse being different from the first and second input variables selected when calculating the Montgomery modular inverse.

2. Method as claimed in claim 1 wherein the first input variable is a and the second input variable is one when calculating a classical modular inverse; and the first input variable is a2^{k} mod(p) and the second input variable is R² when calculating the Montgomery modular inverse.

3. Apparatus for calculating a classical modular inverse or a Montgomery modular inverse of an integer a (mod p), where p is a k-bit integer, comprising:
(5) a first calculating means operable to calculate an “Almost Montgomery Inverse” of a first input variable;
(6) a counting means z;
(7) a second calculating means operable to calculate a Montgomery modular product of the output from the first calculating means and the second input variable in the event that z=k;
(8) a third calculating means operable to calculate a Montgomery modular product of the output of the first calculating means and 2^{2*k-z} in the event that z≠k;
(9) a fourth calculating means operable to calculate a Montgomery modular product of the output from the third calculating means and the second input variable in the event that z≠k;
and further comprising a means of selecting a first and second input variable when calculating the classical modular inverse being different from the first and second input variables selected when calculating the Montgomery modular inverse.

4. Apparatus as claimed in claim 3 wherein the first input variable is a and the second input variable is one when calculating a classical modular inverse and the first input variable is a2^{k} (mod p) and the second input variable is R² when calculating a Montgomery modular inverse.

5. Apparatus as claimed in claim 3 wherein the apparatus further comprises a means of transmitting the output of the fourth calculating means.

6. Apparatus as claimed in claim 3 wherein the second calculating means is implemented in a control unit that further comprises a logic unit which compares z and k.

7. Apparatus as claimed in claim 3 wherein the second, third and fourth calculating means comprise a multiplier unit, an addition unit and a subtraction unit.

8. Apparatus as claimed in claim 7 wherein the addition unit and the subtraction unit employ fast carry chains and two's complement addition.

9. Apparatus as claimed in claim 7 wherein the multiplier unit comprises a plurality of cascaded unsigned multiplier units.

10. Apparatus as claimed in claim 9 wherein the multiplier unit comprises a means of adding the outputs from the unsigned multiplier units employing look-ahead carry chains.

11. Apparatus as claimed in claim 3, wherein the apparatus is a field programmable gate array.

12. Apparatus as claimed in claim 3, wherein the apparatus is an application specific integrated circuit.

13. Apparatus as claimed in claim 3 wherein the apparatus operates on 256 bit data.

14. A method of generating a private encryption key from a public encryption key by calculating the modular inverse of the public encryption key with the method as claimed in claim 1.

15. A method of encrypting data employing the private encryption key generated by the method as claimed in claim 14, wherein the private encryption key is employed in an RSA algorithm.

16. An apparatus for generating a private encryption key from a public encryption key comprising a means for performing the method of claim 14.

17. Digital signature generated from the private key produced by the method of claim 14.

18. A method of encrypting data comprising the steps of:
(d) selecting a point on an elliptical curve;
(e) determining a public key from the point on the elliptical curve and a pre-selected number; and
(f) encrypting the data with the public key
wherein the steps of determining the public key and encrypting the data with the public key employ the method as claimed in claim 1.

19. An apparatus for encrypting data comprising:
(d) a means of selecting a point on an elliptical curve;
(e) a means of determining a public key from the point on the elliptical curve and a pre-selected number; and
(f) a means of encrypting the data with the public key
wherein the means of determining the public key and the means of encrypting the data with the public key employ the apparatus as claimed in claim 3.
